(19) United States
(12) Patent Application Publication
(10) Pub. No.: US 2025/0340400 A1
(43) Pub. Date: Nov. 6, 2025

(54) METHOD AND ELEVATOR

(71) Applicant: Kone Corporation, Helsinki (FI)

(72) Inventors: Riku Lampinen, Helsinki (FI); Juha-Matti Aitamurto, Helsinki (FI)

(73) Assignee: Kone Corporation, Helsinki (FI)

(21) Appl. No.: 19/271,509

(22) Filed: Jul. 16, 2025

Related U.S. Application Data
(63) Continuation of application No. PCT/FI2023/050073, filed on Feb. 6, 2023.

(51) Int. Cl. B66B 1/34; B66B 1/30; B66B 5/00; B66B 11/00

(52) U.S. Cl. CPC B66B 1/3407; B66B 5/0037; B66B 1/30; B66B 11/008

(57) ABSTRACT

The invention relates to a method for testing a traction sheave elevator, which elevator comprises a traction sheave; a motor for rotating the traction sheave; a roping passing around the traction sheave; and a first movable unit; a second movable unit; and a stopping device for stopping descent of the first movable unit. The method comprises performing a test sequence comprising: rotating the motor to move the second movable unit upwards; resisting downwards movement of the first movable unit with the stopping device during said rotating; monitoring torque of the motor during said rotating, comprising detecting if the torque of the motor reaches, in particular rises to, a limit torque during said rotating; monitoring amount or duration of rotation of the motor or the traction sheave during said rotating, comprising detecting if the amount or duration of rotation after said detecting reaches a predetermined limit amount or limit duration; and stopping the rotating if the amount or duration of rotation after said detecting reaches a predetermined limit amount or limit duration. The invention also relates to an elevator implementing the method.

### CROSS-REFERENCE TO RELATED APPLICATION

This application is a continuation of PCT International Application No. PCT/FI2023/050073 which has an International filing date of Feb. 6, 2023, the entire contents of which are incorporated herein by reference.

### FIELD OF THE INVENTION

The invention relates to elevators, and more specifically to testing the elevator. The elevator is an elevator for transporting passengers and/or goods.

### BACKGROUND OF THE INVENTION

Traction sheave elevators typically have an elevator car and a counterweight, which are interconnected by a hoisting roping passing around a traction sheave, which is rotatable by a motor. These movable units of the elevator are on opposite sides of the traction sheave (also known as a traction wheel) such that when one is moved upwards by rotating traction sheave, the other moves downwards. The motor can produce torque on the traction sheave, which torque can be needed for producing rotation on the traction sheave or for producing braking effect of the rotation of the traction sheave.

A stall situation should not take place during normal elevator use if the elevator works as intended. A stall situation during normal elevator use is potentially dangerous situation where slack is caused to the ropes of the hoisting roping. This kind of situation might develop if the descending one of the movable units, for some reason, stops from moving downwards, and the motor continues rotating the traction sheave. In this situation, if the traction is maintained between the ropes and the traction sheave, these keep lifting the ascending one of the movable units. Then, slackness starts to build on the rope portions that are on the opposite side of the traction sheave. If the ropes suddenly slip due to the slack, i.e. reduced tension, on said other side of the traction sheave, the excessively risen movable unit drops until the slack is removed and the ropes are again tensioned on both sides of the traction sheave. The likelihood of a stall situation is most likely to occur in an elevator where the ropes engage very firmly with the traction sheave, for example in an elevator where the rope surface has high friction, e.g. due to a non-metallic coating.

The elevator should not be able to advance into a stall situation. Elevators are commonly tested to ensure they behave safely with regard to stalling. This can be done by driving one of the movable units against its buffer, which will start to resists and eventually bring to halt the downwards movement of the movable unit in question. Rope tension between the traction sheave and the movable unit acted on by the buffer starts to drop. The driving is continued until either the ropes slip on the traction sheave or the motor is stopped by an electric safety device monitoring slack e.g. via monitoring rope tension. When operating correctly, one of these consequences prevents further progress of a stall situation before the slack becomes dangerous. Such a test can thus be used to show that the elevator is working safely as required. A drawback of the testing is that the slipping may be harmful. Even though the elevator works in this respect safely, the slipping may damage the rope surface, which is not a desired side effect of a test situation. Particularly, the surface of a coated rope can be damaged. With such a high traction rope, the electric safety device can be used so as to detect stall before slipping and thereby prevent slipping. However, depending on the system dimensioning, slipping may occur regardless.

In addition to a stalling test, damage through rope slip can be caused in the surface of the rope also in context of testing the safety gear of the elevator. A safety gear includes brakes able to grip the guide rails. A safety gear is intended to be activated in an overspeed situation so as to stop the downwards directed movement of the movable unit. In the testing of a safety gear, descending of one of the movable units is blocked by activated safety gear arranged to grip elevator guide rails. In this test, holding ability of the activated safety gear of the movable unit is tested by driving the other movable unit upwards. This test leads to reduced rope tension of the ropes between the traction sheave and the stationary one of the movable units, correspondingly as in a stalling test. Also in this test, the driving is continued until either the ropes slip on the traction sheave or the motor is stopped by an electric safety device.

### BRIEF DESCRIPTION OF THE INVENTION

The object of the invention is to achieve an improved method and elevator whereby/wherein behavior of the elevator can be tested.

An object is particularly to introduce a solution where the testing can be carried out simply while preventing damage to the ropes of the elevator. An object is particularly to introduce a solution for carrying out a stalling test or a safety gear test can be carried out simply while preventing damage to the ropes of the elevator. An object is particularly to introduce a solution well suitable for elevators utilizing ropes which are sensitive to damaging of their surface, such as coated ropes, for example.

It is brought forward a new a new method for testing a traction sheave elevator, which elevator comprises a traction sheave; a motor for rotating the traction sheave; a roping passing around the traction sheave; a first movable unit and a second movable unit, in particular vertically movable in a hoistway, one of them being an elevator car and the other preferably a counterweight. The movable units are interconnected by the roping, and suspended by the roping on opposite sides of the traction sheave, in particular such that when the traction sheave rotates in its first direction the second movable unit is moved upwards and the first movable unit is moved downwards. The elevator moreover comprises a stopping device for stopping descent of the first movable unit. The method comprises performing a test sequence comprising:
rotating the motor to move the second movable unit upwards; and
resisting downwards movement of the first movable unit with the stopping device during said rotating; and
monitoring torque of the motor during said rotating, comprising detecting (301, also referred to as “first detecting”) if the torque of the motor reaches, in particular rises to, a limit torque (L1) during said rotating; and
monitoring amount or duration of rotation of the motor or the traction sheave during said rotating, comprising detecting (401, also referred to as “second detecting”) if the amount or duration of rotation after said detecting (301, first detecting) reaches a predetermined limit amount (L2) or limit duration (L2′) respectively; and
stopping the rotating if the amount or duration of rotation after said detecting (401, second detecting) reaches a predetermined limit amount (L2) or limit duration (L2′) respectively.

With this kind of solution one or more of the above-mentioned objects can be facilitated. The method is particularly advantageous, because it can prevent severe damage to the ropes of the elevator. An advantage is, that if the test results in slipping of the roping on the traction sheave, the rotation does not continue a long time.

Preferable further details of the method are introduced in the following, which further details can be combined with the method individually or in any combination.

In a preferred embodiment, the whole time of said test sequence, the elevator is out of use for transporting passengers and/or goods.

In a preferred embodiment, the stopping device for stopping descent of the first movable unit is a buffer, preferably mounted stationary in an end of the hoistway in path of the first movable unit, or a safety gear mounted on the first movable unit activatable to stop descent of the first movable unit, preferably comprising one or more gripping means mounted on the first movable unit and activatable to grip one or more guide rails along which the first movable unit is arranged to move.

In a preferred embodiment, the method comprises monitoring tension of the section of the roping that is on the side of the first movable unit of the traction sheave, and detecting (501, also referred to as “third detecting”) if said tension has decreased more than allowed, such as for example below a limit tension, and stopping the rotating if said tension has decreased more than allowed, such as for example below a limit tension. This feature is advantageous since it can stop a stalling situation from progressing before any slip occurs.

In a preferred embodiment, said monitoring tension comprises sensing, preferably by one or more force sensors, tension of the roping, in particular of the section of the roping that is on the side of the first movable unit of the traction wheel, said one or more force sensors comprising one or more force sensors between a stationary structure of the building and the roping, the roping (in particular one or more ropes thereof) being arranged to exert a force on said one or more force sensors, when tensioned.

In a preferred embodiment, said monitoring torque of the motor comprises comparing torque of the motor to a limit torque (L1).

In a preferred embodiment, the method comprises continuing the rotating despite detecting (the first detecting) that the torque of the motor reaches the limit torque during said rotating, in particular such that the torque of the motor rises further above the limit torque (L1).

In the preferred embodiment, the monitoring amount of rotation of the motor or the traction sheave during said rotating comprises determining the amount of rotation of the motor or the traction sheave after the motor torque has reached the limit torque, i.e. the amount the motor or the traction sheave has rotated since the motor torque reached the limit torque. This determining preferably comprises determining, preferably by measuring or calculating, rotation angle of the motor or the traction sheave after motor torque has reached the limit torque L1.

In a preferred embodiment, the amount of rotation and/or the limit amount (L2) of rotation is expressed as an angle or a displacement distance of a surface point of the traction sheave rope driving surface.

In the preferred embodiment of a second kind, the monitoring duration of rotation of the motor or the traction sheave during said rotating comprises determining the duration of rotation of the motor or the traction sheave after the motor torque has reached the limit torque, i.e. the time the motor or the traction sheave has rotated since the motor torque reached the limit torque. The determining preferably comprises measuring the time the motor or the traction sheave has rotated since the motor torque reached the limit torque.

In the preferred embodiment of a second kind, the limit duration of rotation is a time, e.g. expressed in seconds, in which an amount of rotation of the motor or the traction sheave occurs with a rotation speed by which the rotation is performed after said detecting (first detecting), where the amount of rotation corresponds to displacement distance, which is between 5 and 20 cm, preferably between 5 and 15 cm, most preferably about 10 cm, of a surface point of the traction sheave rope driving surface.

In a preferred embodiment, the method comprises before performing said test sequence preparing the elevator for a test sequence comprising:
removing the elevator from use for transporting passengers and/or goods; and/or
driving (101) the first movable unit to a proximity of a buffer or activating (101′) a safety gear mounted on the first movable unit.

In a preferred embodiment, the limit torque (L1) is substantially higher than a reference torque TO needed for producing rotation in the motor before the test sequence.

In a preferred embodiment, the limit torque (L1) is preferably represented by a limit torque value (L1).

In a preferred embodiment,
the limit torque value (L1) is a preset limit torque value (L1), e.g. input in the control system of the elevator; or
the limit torque value (L1) is received by input through a user interface during the method, in particular by the control system 10;20 of the elevator; or
the limit torque value (L1) is determined by the control system of the elevator, in particular during the method.

In a preferred embodiment, the aforementioned steps [in particular rotating, monitoring torque, monitoring amount or duration of rotation, stopping the rotating, and preferably also a step of monitoring tension] of the test sequence are performed by a control system of the elevator.

In a preferred embodiment, the method comprises determining the limit torque (L1).

In a preferred embodiment, the motor is an electric motor.

In a preferred embodiment, said rotating comprises exerting a torque by the motor on the traction sheave by which torque the motor urges the traction sheave to turn to the first direction to move the second movable unit upwards.

In a preferred embodiment, the first movable unit is a counterweight and the second movable unit is an elevator car.

In a preferred embodiment, the limit amount (L2) of rotation is an amount of rotation corresponding to displacement distance, which is between 5 and 20 cm, preferably between 5 and 15 cm, most preferably about 10 cm, of a surface point of the traction sheave rope driving surface.

In a preferred embodiment, the elevator is an elevator for transporting passengers and/or goods. The car preferably also comprises one or more doors by which the doorway can be opened and closed. The door is preferably an automatic door, whereby comfortable and safe elevator use can be provided by the elevator solution.

It is also brought forward a new traction sheave elevator, which elevator comprises
a traction sheave;
a motor for rotating the traction sheave;
a roping passing around the traction sheave;
a first movable unit and a second movable unit, in particular vertically movable in a hoistway, one of them being an elevator car and the other preferably a counterweight, which movable units (5,6;25,26) are interconnected by the roping, and suspended by the roping on opposite sides of the traction sheave, in particular such that when the traction sheave rotates in its first direction the second movable unit is moved upwards and the first movable unit is moved downwards;
a stopping device for stopping descent of the first movable unit;
wherein the elevator comprises a control system (10;20) configured to perform a test sequence (1000), and as part of the test sequence (1000):
to rotate the motor to move the second movable unit upwards while downwards movement of the first movable unit is resisted by the stopping device; and
to monitor torque of the motor during said rotating, and to detect (301, first detecting) if the torque of the motor reaches a limit torque (L1) during said rotating; and
   to monitor amount or duration of rotation of the motor or the traction sheave during said rotating, and to detect (401, second detecting) if the amount or duration of rotation after said detecting (301, first detecting) reaches a predetermined limit amount (L2) or limit duration (L2′) respectively; and
to stop the rotating if the amount or duration of rotation after said detecting (401, second detecting) reaches a predetermined limit amount (L2) or limit duration (L2′) respectively.

With this kind of solution one or more of the above-mentioned objects can be facilitated.

Preferable further details of the elevator are introduced in the following, which further details can be combined with the elevator individually or in any combination.

In a preferred embodiment, the control system is configured to perform one or more of the following steps of the method as defined anywhere above: rotating, monitoring torque, monitoring amount of rotation, stopping the rotating, monitoring tension, preparing the elevator for a test sequence.

### BRIEF DESCRIPTION OF THE DRAWINGS

In the following, the present invention will be described in more detail by way of example and with reference to the attached drawings, in which

FIG. 1 illustrates schematically an elevator according to a first embodiment implementing a method according to a first embodiment.

FIG. 2 illustrates steps of the method.

FIG. 3 illustrates an example of a torque curve of the elevator of FIG. 1 realized in the method.

FIG. 4 illustrates schematically an elevator according to a second embodiment implementing a method according to a second embodiment.

### DETAILED DESCRIPTION

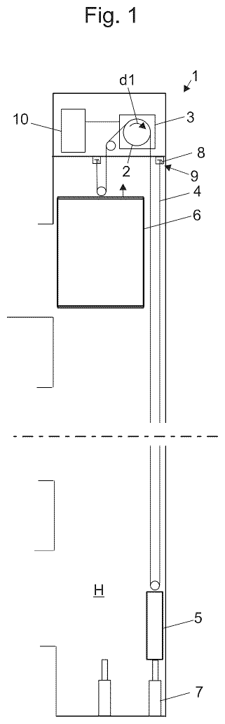

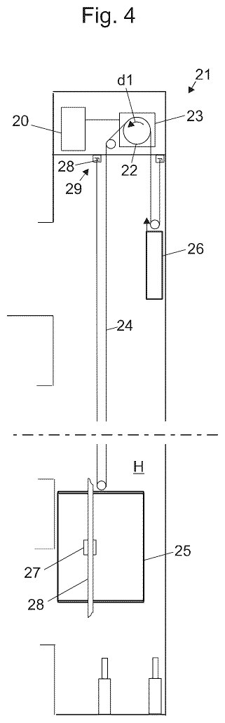

FIGS. 1 and 4 illustrate each a traction sheave elevator 1;21 according to an embodiment. In each embodiment, the elevator 1;21 comprises a traction sheave 2;22, a motor 3;23, in particular an electric motor, for rotating the traction sheave 2;22 and a roping 4;24 passing around the traction sheave 2;22. The elevator 1;21 moreover comprises a first movable unit 5;25 and a second movable unit 6;26. These elevator units are vertically movable in a hoistway H, one of them being an elevator car and the other preferably a counterweight, but alternatively it could be an elevator car as well. The movable units 5,6;25,26 are interconnected by the roping 4;24, and suspended by the roping 4;24 on opposite sides of the traction sheave 2;22, in particular such that when the traction sheave 2;22 rotates in its first direction the first movable unit 5;25 is moved downwards and the second movable unit 6;26 is moved upwards. The roping 4;24 preferably comprises one or more ropes. The elevator 1;21 moreover comprises a stopping device 7;27 for stopping descent of the first movable unit 5;25. In the elevator of FIG. 1, the first movable unit is a car of the elevator. In the elevator of FIG. 4, the first movable unit is a car of the elevator.

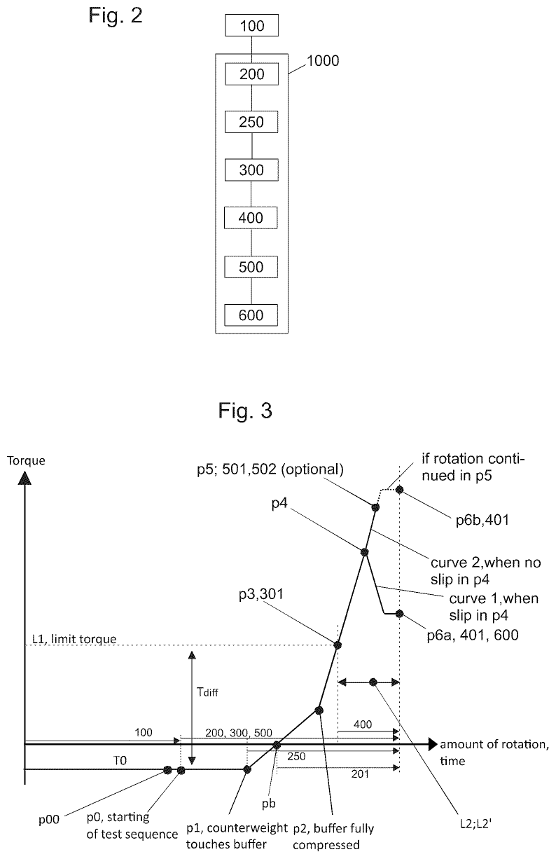

Each illustrated elevator 1;21 is configured to implement a method for testing the traction sheave elevator 1;11;21, as illustrated in FIG. 2. The method comprises performing a test sequence 1000.

In the following, the method implemented in the elevator of FIG. 1 is described in more detail. In the elevator of FIG. 1, the stopping device 7 for stopping descent of the first movable unit 5 is a buffer 7. The buffer is in the preferred embodiment mounted stationary in an end of the hoistway in path of the first movable unit 5. In the method, a preparing 100 the elevator 1 for a test sequence is first performed, as illustrated in FIG. 2. This step comprises driving 101 the first movable unit 5 to a proximity of a buffer 7. For safety and uninterrupted testing, the elevator is preferably out of use for transporting passengers and/or goods the whole time of said test sequence 1000. For this purpose, said preparing 100 also comprises removing the elevator 1 from use for transporting passengers and/or goods. This comprises in particular preventing movement of the elevator units 5,6 as well as rotation of motor 2, based on signals received from user interfaces, such as from user interfaces positioned at landings.

After said preparing 100, the method comprises performing a test sequence 1000. FIG. 1 illustrates the elevator at the moment when the test sequence 1000 is being performed. FIG. 3 illustrates a torque curve as well as occurrences of the method and test sequence 1000 in function of time and amount of rotation.

As illustrated in FIG. 3, the test sequence 1000, performed after said preparing 100, comprises, rotating 200 the motor 3 to move the second movable unit 6;26, i.e. the car 6, upwards. In FIG. 3, the rotating is started at point p0.

The test sequence 1000 moreover comprises resisting 250 downwards movement of the first movable unit 5 with the stopping device 7 during said rotating 200. The resistance simulates a situation where in the elevator use the free movement of the first elevator unit would be obstructed for some reason. Thus, behavior of the elevator in such a situation can be tested by the method.

More specifically, referring to FIGS. 1-3, the rotating 200 is performed such that the traction sheave 4 rotates in a first direction d1 to move the second movable unit 6 upwards such that the first movable unit 5 moves towards the stopping device 7, i.e. the buffer, and touches it. This touching is shown in point p1 in FIG. 2. In point p1 the stopping device 7 starts to cause a resisting effect on the movement of the first movable unit 5, which resisting effect starts to change the force balance situation of the elevator units. Particularly, torque needed from the motor 3 for achieving movement of the second elevator unit 6 increases.

From point p1 onwards, the rotating 200 the motor 3 continues such that the traction sheave 4 rotates to move the second movable unit 6, here the car 6, upwards while downwards movement of the first movable unit 5, here the counterweight, is resisted by the stopping device 7, i.e. the buffer 7. Due to this resistance, the torque curve starts to rise at point p1 in FIG. 3.

In the test sequence 1000, torque of the motor 3 is monitored 300 during said rotating 200. This monitoring 300 comprises detecting 301 if the torque of the motor 3 reaches, in particular rises to, a limit torque L1 during said rotating 200. This detecting 301 is illustrated to occur at point p3 in FIG. 2. The method comprises continuing the rotating 200 despite detecting 301 that the torque of the motor reaches the limit torque during said rotating, in particular such that the torque of the motor 3 rises further above the limit torque L1. Thus, reaching the limit torque L1 does not cause stopping of the test sequence 1000.

In the test sequence 1000, amount of rotation of the motor 3;23 or the traction sheave 4 is monitored 400 during said rotating 200. This monitoring 400 comprises detecting 401 if the amount of rotation after said detecting 301 reaches a predetermined limit amount L2; and stopping 600 the rotating 200 if the amount of rotation after said detecting 301 reaches a predetermined limit amount L2. Thus, in the test sequence, the amount of rotation after the torque has risen to the torque limit L1, can be limited to certain maximum amount. The advantage is, that if the test results in slipping of the roping on the traction sheave, the rotation does not continue a long time. The amount of rotation and the limit amount L2 of rotation are preferably expressed as angle or displacement distance, the units preferably then being degrees or centimeters (or inches) respectively. In general, the limit amount of rotation L2 is preferably an amount of rotation corresponding to a displacement distance of a surface point e.g. rim point of the traction sheave rope driving surface, which distance is preferably between 5 and 20 cm, preferably between 5 and 15 cm, most preferably about 10 cm. Within this range, in most elevators it is likely a testing result is achieved without harming the ropes excessively.

The method preferably moreover comprises monitoring 500 tension of the section of the roping 4 that is on the side of the first movable unit 5;25 of the traction sheave 2, and detecting 501 if said tension has decreased more than allowed, such as for example below a limit tension L3 not shown, and stopping 502 the rotating 200 if said tension has decreased more than allowed, such as for example below a limit tension L3. This part of the roping 4 will become gradually slacker when during the rotating 200, since the first elevator unit 5 becomes more and more carried by the buffer 7. The monitoring step 500 is not necessary, because the elevator slip of roping can stop a stalling situation from progressing. However, said step 500 is advantageous since it can stop a stalling situation from progressing before any slip occurs.

FIG. 3 illustrates two exemplary curves that may be realized in two different behaviour scenarios of the elevator 1 during the test sequence 1000. The curves differ from the point p4 onwards. Curve 1 shows torque when the roping slips at the point p4. This is a possible consequence of the test sequence, and occurs if due to the weight of the elevator unit 6, the traction between roping 4 and the traction sheave 3 is lost. In this case, if the rotation continues, as it is illustrated in FIG. 3, at point p6a it is detected 401 that the amount of rotation after said detecting 301 reaches a predetermined limit amount L2 and the motor is stopped at said point p6a. In the case of the exemplary curve 1, the roping would slip and the traction sheave would slip against each other only about 5 cm if the limit amount L2 of rotation corresponds to 10 cm displacement distance of a rim point of the traction sheave 3, for example. Stopping the motor 2 upon reaching the limit amount L2 thus effectively protects the system from great amount of slip.

Curve 2 shows torque when the roping does not slip at the point p4. This too is a possible consequence of the test sequence 1000, and likely for example if the ropes of the roping 4 are high friction ropes e.g. coated by polymer based coating and occurs if the weight of the elevator unit 6 does not exceed the traction between roping 4 and the traction sheave 3. In this case, if the rotation continues, as it is illustrated in FIG. 3. In FIG. 3, the aforementioned monitoring 500 of tension is being implemented, and at point p5 of the curve 2, the tension has decreased more than allowed, such as for example below a limit tension L3. This is detected 501 at point p5, and the rotating 200 is stopped 502. Stopping 502 protects from further progress of a potentially dangerous situation where the roping 4 has slackened. FIG. 3 illustrates by broken line that continues from point p5, how the curve 2 would proceed if the monitoring 500 would be omitted or if it would malfunction. Also in these cases, the limit amount L2 makes the system safer. As illustrated by the broken line, torque keeps rising after reaching point p4 at least until the counterweight 5 is fully suspended by the buffer 7. If the monitoring 500 would be omitted or if it would malfunction, at point p6b it is detected 401 that the amount of rotation after said detecting 301 reaches a predetermined limit amount L2 and the rotating 200 of the motor 2 is stopped at said point p6b. Stopping the motor 2 upon reaching the limit amount L2 thus effectively protects the system from great amount of slack.

In the method, said monitoring 300 torque of the motor 3;23 is implemented in the preferred embodiment such that said monitoring 300 comprises comparing torque of the motor 3 to a limit torque L1. This is preferably done intermittently or continuously during the rotating 200 at least until said limit torque L1 is reached.

In the preferred embodiment, the monitoring 400 amount of rotation of the motor 3 or the traction sheave 4 during said rotating 200 comprises determining the amount of rotation of the motor 3 or the traction sheave 2 after motor torque has reached a limit torque L1, i.e. the amount the motor 3 or the traction sheave 2 has rotated since the motor torque reached the limit torque. This determining amount of rotation preferably comprises determining, preferably by measuring or calculating, rotation angle of the motor 3 or the traction sheave 4 after motor torque has reached a limit torque L1. Rotation angle of a motor is normally simply obtainable.

The limit torque L1 may be different in different elevators depending on the weight balance during the test sequence. Thus, the appropriate limit torque L1 depends on the elevator in question.

In general, the limit torque L1 is substantially higher than a reference torque TO needed for producing rotation in the motor 3 at a moment before the test sequence, and in particular at a moment point p00 in FIG. 3 when downwards movement of the first movable unit 5 is not resisted by the stopping device 7. The limit torque L1 is preferably represented by a limit torque value L1. The reference torque is preferably represented by a reference torque value TO.

Said rotating 200 comprises exerting 201 a torque by the motor on the traction sheave 4 by which torque the motor urges the traction sheave 4 to turn to first direction d1, in particular to move the second movable unit 6 upwards. This is realized in FIG. 3 from point pb onwards. Hereby, from point pb onwards, the motor torque causes instead of breaking the rotation in said first direction d1.

In FIG. 3, Tdiff is the torque difference between points p00 and p3. In the presented case, the force balance situation is such that the counterweight 5 is heavier than the empty car in FIG. 1, whereby in the starting point p00 of the test sequence 1000, the motor torque direction changes during the test sequence 1000.

In the example of FIG. 3, due to the initial force balance, the rotating 200 initially before point pb exerts a torque by the motor on the traction sheave 4 by which torque the motor breaks turning of the traction sheave 4 to first direction. Thus, controlled release of suspension of the first unit is achieved in the balance situation of the example.

In general, the limit torque L1 is preferably substantially smaller than a torque slip torque where slip is expected, i.e. lower than the torque at point p4. The limit torque L1 should in FIG. 3 be between the torque needed for rotation at points p1 and p4. The appropriate value for the limit torque L1 can be found by testing the elevator in question or a corresponding elevator or by calculation.

The limit torque value L1 is preferably in accordance with one of the following:
A) The limit torque value L1 is a preset limit torque value L1, e.g. input in the control system 10 of the elevator.
B) The limit torque value L1 is received by input through a user interface during the method, in particular by the control system 10 of the elevator.
C) The limit torque value L1 is determined by the control system 10 of the elevator, in particular during the method. In this case, preferably, the method comprises determining the limit torque L1, this determining can be performed as part of the test sequence 1000 or before it. Preferably then, the preparing 100 comprises said step of determining the limit torque L1. In the determining, the control system 10 of the elevator calculates the limit torque value L1 based on plurality of variables of the elevator including preferably at least car location and prevailing load of the car. Thus, an appropriate value for the limit torque can be calculated e.g. beforehand taking into consideration the intended testing conditions and properties of the elevator.

In the following, the method implemented in the elevator of FIG. 4 is described in more detail. In the elevator of FIG. 4, the stopping device 27 for stopping descent of the first movable unit 5;25 is a safety gear 27 mounted on the first movable unit 5;25, here the car, and activatable to stop descent of the first movable unit 25. The safety gear preferably comprises one or more gripping means mounted on the first movable unit 25 and activatable to grip one or more guide rails 28 along which the first movable 25 unit is arranged to move.

In the method, a preparing 100 the elevator 1;11;21 for a test sequence is first performed, as illustrated in FIG. 2. In the embodiment of FIG. 4, this step comprises activating a safety gear 27 mounted on the first movable unit 25. For safety and uninterrupted testing, the elevator is preferably out of use for transporting passengers and/or goods the whole time of said test sequence 1000. For this purpose, said preparing 100 also comprises removing the elevator 1 from use for transporting passengers and/or goods. This comprises in particular preventing movement of the elevator units 5,6 as well as rotation of motor 2, based on signals received from user interfaces, such as from user interfaces positioned at landings.

After said preparing 100, the method comprises performing a test sequence 1000. FIG. 4 illustrates the elevator at the moment when the test sequence 1000 is being performed.

The test sequence 1000, performed after said preparing 100, comprises, rotating 200 the motor 3;23 to move the second movable unit 6;26, i.e. the counterweight 6, upwards.

The test sequence 1000 moreover comprises resisting 250 downwards movement of the first movable unit 5;25, i.e. the car, with the stopping device 7;27 during said rotating 200. The resistance simulates a situation where in the elevator use the free movement of the first elevator unit would be obstructed for some reason. Thus, behavior of the elevator in such a situation can be tested by the method.

More specifically, the rotating 200 is performed such that the traction sheave 24 rotates in a first direction d1′ to move the second movable unit 26 upwards such that the first movable unit 25 is lowered to increasingly rest carried by the safety gear. This starts to change the force balance situation of the elevator units. Particularly, the torque needed from the motor 23 for achieving movement of the counterweight increases.

The rotating 200 the motor 23 continues such that the traction sheave 24 rotates to move the second movable unit 26, here the car 6, upwards while downwards movement of the first movable unit 25, here the counterweight, is resisted by the stopping device 27, i.e. safety gear. Due to this resistance, the torque of the motor 3 rises.

In the test sequence 1000, torque of the motor 23 is monitored 300 during said rotating 200. This monitoring 300 comprises detecting 301 if the torque of the motor 23 reaches, in particular rises to, a limit torque L1 during said rotating 200. The method comprises continuing the rotating 200 despite detecting that the torque of the motor 23 reaches the limit said detecting 301 such that the torque of the motor 23 rises further above the limit torque L1. Thus, reaching the limit torque L1 does not cause stopping of the test sequence 1000.

In the test sequence 1000, amount of rotation of the motor 23 or the traction sheave 24 is monitored 400 during said rotating 200. This monitoring 400 comprises detecting 401 if the amount of rotation after said detecting 301 reaches a predetermined limit amount L2; and stopping 600 the rotating 200 if the amount of rotation after said detecting 301 reaches a predetermined limit amount L2. Thus, in the test sequence, the amount of rotation after the torque has risen to the torque limit L1, can be limited to certain maximum amount. The advantage is, that if the test results in slipping of the roping on the traction sheave, the rotation does not continue a long time. The limit amount L2 of rotation can be expressed preferably as angle or displacement distance, for example, the units preferably then being degrees or centimeters (or inches) respectively. However, the limit amount of rotation L2 is an amount of rotation corresponding to a displacement distance of a surface point e.g. rim point of the traction sheave rope driving surface, which distance is preferably between 5 and 20 cm, preferably between 5 and 15 cm, most preferably about 10 cm. Within this range, in most elevators it is likely a testing result is achieved without harming the ropes excessively.

The method preferably moreover comprises monitoring 500 tension of the section of the roping 24 that is on the side of the first movable unit 25 of the traction sheave 2, and detecting 501 if said tension has decreased more than allowed, such as for example below a limit tension L3 not shown, and stopping 502 the rotating 200 if said tension has decreased more than allowed, such as for example below a limit tension L3. This part of the roping 4 will become gradually slacker when during the rotating 200, since the first elevator unit 25 becomes more and more carried by the safety gear 27. The monitoring step 500 is not necessary, because the elevator slip of roping can stop a stalling situation from progressing. However, said step 500 is advantageous since it can stop a stalling situation from progressing before any slip occurs.

In the preferred embodiments, steps 200,300,400,500 and 600 of the test sequence 1000 are performed by a control system 10;20 of the elevator. Also the step 100 can be performed by a control system 10;20 of the elevator. The control system 10;20 of the elevator preferably comprises one or more microprocessors.

The traction sheave elevator 1;11;21 according to an embodiments are illustrated in FIGS. 1 and 4. In both cases, the elevator comprises a control system 10;20 configured to perform a test sequence 1000. The control system 10;20 is configured as part of the test sequence 1000:
to rotate 200 the motor 3;23 to move the second movable unit 6;26 upwards while downwards movement of the first movable unit 5;25 is resisted 250 by the stopping device 7;27; and
to monitor 300 torque of the motor 3;23 during said rotating 200, and to detect 301 if the torque of the motor 3;23 reaches a limit torque L1 during said rotating 200; and
   to monitor 400 amount of rotation of the motor 3;23 or the traction sheave 4;24 during said rotating 200, and to detect 401 if the amount of rotation after said detecting 301 reaches a predetermined limit amount L2; and
   to stop 600 the rotating 200 if the amount of rotation after said detecting 301 reaches a predetermined limit amount L2.

Preferred details of these steps have been described above referring to the method.

Generally, in the method said tension monitoring 500 can be implemented in various alternative ways. Preferably, said monitoring 500 comprises sensing, preferably by one or more force sensors 8;28, tension of the roping 4;24, in particular of the section of the roping 4;24 that is on the side of the first movable unit 5;25 of the traction sheave 2;22.

Said one or more force sensors 8;28 preferably comprise one or more force sensors between a stationary structure and the roping 4;24, the roping [in particular one or more ropes thereof] being arranged to exert, when tensioned, a force on said one or more force sensors 8;28 either directly or indirectly via one or more force transmitting components, i.e. components able to transmit forces between the roping and the force sensors. Accordingly, the sensing could be direct sensing of the tension or indirect sensing. However, also the monitoring 500 could be arranged also by indirect sensing of the tension by sensing a parameter dependent on said tension. In FIGS. 1 and 4, the elevator 1 comprises a rope terminal device 9;29, comprising one or more force sensors 8;28 between a stationary structure a frame of the terminal device 9;29 and the roping 4;24, the roping [in particular one or more ropes thereof] being arranged to exert, when tensioned, a force on said one or more force sensors 8;28.

Generally, it is not necessary in embodiment of FIG. 1 that the elevator unit the descending of which is resisted is a counterweight. For example, the testing of the elevator 1 could be alternatively arranged such that the first movable unit 5 is a car of the elevator, and the second elevator unit 6 is the counterweight.

Generally, it is not necessary in embodiment of FIG. 4 that the elevator unit the descending of which is resisted is a car. For example, the testing of the elevator 21 could be alternatively arranged such that the first movable unit 25 is a counterweight of the elevator, and the second elevator unit 6 is the car.

In the examples above, a method is described, where a preparing 100 preferably comprises removing the elevator 1 from use for transporting passengers and/or goods. The preparing may also comprise changing the elevator mode, in particular away from its normal operation mode. It is however not necessary that the method comprises changing the elevator mode. For example, the method can be performed whatever the mode of the elevator is. The testing method can thus be a scheduled or non-scheduled self-testing method of the elevator, for example.

In the embodiments described above, amount rotation of the motor 3;23 or the traction sheave 4;24 during said rotating 200 is monitored in said monitoring 400. In an embodiment of a second type, duration of rotation of the motor 3;23 or the traction sheave 4;24 during said rotating 200 is monitored in said monitoring 400. Then the monitoring 400 comprises detecting 401 if the duration of rotation after said detecting 301 reaches a predetermined limit duration L2′. In this case, the stopping 600 the rotating 200 is performed if the duration of rotation after said detecting 301 reaches a predetermined limit duration L2′.

In the second type of embodiment, the method comprises determining the duration of rotation of the motor 3;23 or the traction sheave 2;22 after the motor torque has reached the limit torque L1. The duration of rotation is preferably a time, preferably expressed in seconds. The limit duration L2′ of rotation is a time, preferably expressed in seconds, in which time an amount of rotation of the motor 3;23 or the traction sheave 2;22 occurs with a rotation speed by which the rotation 200 is performed after said detecting 301, where the amount of rotation corresponds to displacement distance, which is between 5 and 20 cm, preferably between 5 and 15 cm, most preferably about 10 cm, of a surface point of the traction sheave rope driving surface. The rotating 200 is preferably performed with a preset rotation speed. The preset rotation speed is known in advance and it can then be used to calculate and set (in advance) a value for the limit duration L2′ such that the amount of rotation of the motor 3;23 or the traction sheave 2;22 is realized if the rotating 200 is continued the time of said limit duration L2′ after said detecting 301.

In general, in the second type of embodiment, the duration of rotation is, instead of the amount, the parameter under monitoring. In other aspects the second type of embodiment is similar as described earlier referring to other embodiments.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. A method for testing a traction sheave elevator, which elevator comprises
a traction sheave;
a motor for rotating the traction sheave;
a roping passing around the traction sheave;
a first movable unit and a second movable unit, one of them being an elevator car and the other preferably a counterweight, which movable units are interconnected by the roping, and suspended by the roping on opposite sides of the traction sheave, in particular such that when the traction sheave rotates in its first direction the second movable unit is moved upwards and the first movable unit is moved downwards;
a stopping device for stopping descent of the first movable unit;
wherein the method comprises
performing a test sequence comprising:
rotating the motor to move the second movable unit upwards; and
resisting downwards movement of the first movable unit with the stopping device during said rotating; and
monitoring torque of the motor during said rotating, comprising detecting if the torque of the motor reaches, in particular rises to, a limit torque during said rotating; and
monitoring amount or duration of rotation of the motor or the traction sheave during said rotating, comprising detecting if the amount or duration of rotation after said detecting reaches a predetermined limit amount or limit duration; and
stopping the rotating if the amount or duration of rotation after said detecting reaches a predetermined limit amount or limit duration.

2. A method according to claim 1, wherein the stopping device for stopping descent of the first movable unit is a buffer, or a safety gear mounted on the first movable unit and activatable to stop descent of the first movable unit.

3. A method according to claim 1, wherein the method comprises monitoring tension of the section of the roping that is on the side of the first movable unit of the traction sheave, and detecting if said tension has decreased more than allowed, such as for example below a limit tension, and stopping the rotating if said tension has decreased more than allowed, such as for example below a limit tension.

4. A method according to claim 1, wherein said monitoring torque of the motor comprises comparing torque of the motor to a limit torque.

5. A method according to claim 1, wherein the method comprises continuing the rotating despite detecting that the torque of the motor reaches the limit torque during said rotating such that the torque of the motor rises further above the limit torque.

6. A method according to claim 1, wherein the method comprises determining the amount of rotation of the motor or the traction sheave after motor torque has reached the limit torque.

7. A method according to claim 1, wherein the limit amount of rotation is an amount of rotation corresponding to displacement distance, which is between 5 and 20 cm, preferably between 5 and 15 cm, most preferably about 10 cm, of a surface point of the traction sheave rope driving surface.

8. A method according to claim 1, wherein the method comprises determining the duration of rotation of the motor or the traction sheave after the motor torque has reached the limit torque.

9. A method according to claim 1, wherein the limit duration of rotation is a time, e.g. expressed in seconds, in which an amount of rotation of the motor or the traction sheave occurs with a rotation speed by which the rotation is performed after said detecting, where the amount of rotation corresponds to displacement distance, which is between 5 and 20 cm, preferably between 5 and 15 cm, most preferably about 10 cm, of a surface point of the traction sheave rope driving surface.

10. A method according to claim 1, wherein the method comprises before performing said test sequence preparing the elevator for a test sequence comprising:
removing the elevator from use for transporting passengers and/or goods; and/or
driving the first movable unit to a proximity of a buffer or activating a safety gear mounted on the first movable unit.

11. A method according to claim 1, wherein the limit torque is substantially higher than a reference torque TO needed for producing rotation in the motor before the test sequence.

12. A method according to claim 1, wherein the limit torque is preferably represented by a limit torque value.

13. A method according to claim 1, wherein
the limit torque value is a preset limit torque value, e.g. input in the control system of the elevator; or
the limit torque value is received by input through a user interface during the method, in particular by the control system of the elevator; or
the limit torque value is determined by the control system of the elevator, preferably during the method.

14. A method according to claim 1, wherein the aforementioned steps of the test sequence are performed by a control system of the elevator.

15. A method according to claim 1, wherein the method comprises determining the limit torque.

16. A method according to claim 1, wherein the motor is an electric motor.

17. A method according to claim 1, wherein said rotating comprises exerting a torque by the motor on the traction sheave by which torque the motor urges the traction sheave to turn to first direction to move the second movable unit upwards.

18. A method according to claim 1, wherein the first movable unit is a counterweight and the second movable unit is an elevator car.

19. A traction sheave elevator, which elevator comprises
a traction sheave;
a motor for rotating the traction sheave;
a roping passing around the traction sheave;
a first movable unit and a second movable unit, one of them being an elevator car and the other preferably a counterweight, which movable units are interconnected by the roping, and suspended by the roping on opposite sides of the traction sheave, in particular such that when the traction sheave rotates in its first direction the second movable unit is moved upwards and the first movable unit is moved downwards;
a stopping device for stopping descent of the first movable unit;
wherein the elevator comprises a control system configured to perform a test sequence, and as part of the test sequence:
to rotate the motor to move the second movable unit upwards while downwards movement of the first movable unit is resisted by the stopping device; and
to monitor torque of the motor during said rotating, and to detect if the torque of the motor reaches a limit torque during said rotating; and
to monitor amount of rotation or duration of the motor or the traction sheave during said rotating, and to detect if the amount or duration of rotation after said detecting reaches a predetermined limit amount or limit duration; and
to stop the rotating if the amount or duration of rotation after said detecting reaches a predetermined limit amount or limit duration.

20. A control system for a traction sheave elevator, wherein the control system is configured to perform the method of claim 1.
